(19) United States
(12) Patent Application Publication
(10) Pub. No.: US 2015/0286962 A1
(43) Pub. Date: Oct. 8, 2015

(54) METHOD AND COMPUTER PROGRAM PRODUCT FOR ANALYZING AIRLINE PASSENGER TICKET MASS DATA STOCKS

(71) Applicant: Deutsche Lufthansa AG, Cologne (DE)

(72) Inventors: Karl Echtermeyer, Hofheim (DE); Werner Coenen, Frankfurt (DE)

(21) Appl. No.: 14/558,749

(22) Filed: Dec. 3, 2014

(30) Foreign Application Priority Data
Apr. 2, 2014 (EP) 14163109.3

(51) Int. Cl. G06Q 10/02; G06Q 40/00

(52) U.S. Cl. CPC G06Q 10/02; G06Q 40/12

(57) ABSTRACT

A method for analyzing airline passenger ticket mass data stocks includes linking ticket data with flight schedule information so as to form a database comprising ticket coupon data for each flight event. It is ensured that individual ticket coupons for each flight event are sorted in accordance with respective ticket coupon receipts in a predefined order. Receipts are determined for each flight event as a function of a number of a serial passenger code number in accordance with the sorted ticket coupons. Calibration parameters of a function Yᵢ(X) are determined for each individual flight event i. Calibration of the function Yᵢ(X) is carried out based on the determined receipts as a function of the serial passenger code number in such a way that deviations of functional values Yᵢ from the determined receipts are as small as possible. Calibrated functions are combined into clusters for assignment based on flight information.

### CROSS-REFERENCE TO PRIOR APPLICATION

Priority is claimed to European Patent Application No. EP 14 163 109.3, filed on Apr. 2, 2014, the entire disclosure of which is hereby incorporated by reference herein.

### FIELD

The invention relates to a method and to a computer program product for analyzing airline passenger ticket mass data stocks.

### BACKGROUND

Airlines have extensive information relating to flights carried out in the past. At least some of this information is stored in airline passenger ticket mass data stocks. These data stocks contain a data set for each individual ticket sold by the airline, wherein a data set comprises, for example, information about the flight route, the date of the flight and the price of the ticket.

In particular, owing to the concentration of companies which has taken place in the field of civil aviation and which has basically resulted in globally operating airlines with large route networks and very large numbers of flight movements, an airline passenger ticket mass data stock of an airline is usually of considerable size, in particular in the cases in which a mass data stock extends over more than one calendar year.

In every airline there is usually a large amount of interest in using the respective airline passenger ticket mass data stock to obtain information which can serve as a basis for company decisions. These decisions can include changes to the flight schedule (for example cancellation of routes, changing of departure time or arrival time, changing of the frequency on individual routes, changing of the aircraft etc., used on specific routes), fleet planning (for example decommissioning or sale of aircraft of a specific size and range) or creation of a demand profile for new aircraft which can then be made available to an aircraft manufacturer as a starting point for a new development.

For this purpose, it is known in the prior art to determine individual key figures from an airline passenger ticket mass data stock. For example, in this way the total receipts for a predefined route in a predefined time period can be determined from the airline passenger ticket mass data stock by adding up the prices of the tickets of the data sets which meet the corresponding boundary conditions. The number of passengers carried on a specific route in a predefined time period can also be determined. By linking these two information items it is possible to calculate the average receipts per passenger carried. The (average) receipts can also be determined separately for each passenger class (for example, “first”, “business”, “economy”), which, however, gives rise to a corresponding increase in the number of key figures.

In order to provide a supposedly sufficient and well-founded basis for the decisions mentioned above, the specified key figures must be determined for all the flights carried out by an airline within at least one year, frequently even for a time series of more than a year. Owing to the sheer size of airline passenger ticket mass data stocks which is usually the case, particularly powerful computers are necessary for the corresponding determination of these key figures, but these computers require a considerable period of time for this purpose.

Owing to these technical conditions, the analysis of airline passenger ticket mass data stocks is generally limited in the prior art exclusively to determining a predefined quantity of key figures, which are then fed as static values to a further static evaluation unit. The quantity of key figures determined is selected here in such a way that the amount of said key figures can also be further processed by less powerful computers.

For strategic decisions, the determined key figures are combined with assumed or strategically estimated correction factors. However, comprehensive checking of the correction factors for plausibility on the basis of the airline passenger ticket mass data stocks is virtually impossible here. This would in fact require data analysis of the airline passenger ticket mass data stocks which is extremely time-consuming, ties up personnel resources, is computationally intensive and can basically be carried out only on extremely powerful computers, and even there would take a considerable period of time. Since corresponding computer capacity is usually not available for a corresponding data analysis at airlines, in the prior art corresponding checking was basically dispensed with. Owing to a lack of practical possibilities in use in the prior art, there are not yet models with which a data analysis which is suitable for the specified purposes would be possible.

In the prior art, the analysis of large airline passenger ticket mass data stocks is therefore usually limited to determining a quantity of predefined characteristic variables owing to limitations of the computer capacity. However, these key figures are static variables, on the basis of which changes can be estimated only subjectively, for example in the form of “strategic reductions” with which, for example, changed market conditions should be allowed for. More wide-ranging information cannot be acquired from the airline passenger ticket mass data stocks in the prior art because of usually limited computer capacity.

### SUMMARY

In an embodiment, the present invention provides a method for analyzing airline passenger ticket mass data stocks. In a step a., ticket data is linked with flight schedule information so as to form a database comprising ticket coupon data for each flight event. In a step b., it is ensured that individual ticket coupons for each flight event are sorted in accordance with respective ticket coupon receipts in a predefined order. In a step c., receipts are determined for each flight event as a function of a number of a serial passenger code number in accordance with the sorted ticket coupons. In a step d., calibration parameters of a function Yᵢ(X) are determined for each individual flight event i, where Yᵢ stands for the receipts and X stands for the serial passenger code number. Calibration of the function Yᵢ(X) is carried out based on the determined receipts as a function of the serial passenger code number in such a way that deviations of functional values Yᵢ from the determined receipts are as small as possible. In a step e., a plurality of calibrated functions are combined into clusters which are assignable based on flight information.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1: shows a schematic illustration of the method according to an embodiment of the invention,

FIG. 2: shows a detail from a ticket coupon database;

FIG. 3: shows a diagram of the ticket receipts as a function of the serial passenger code number;

FIG. 4: shows a diagram of the cumulated receipts as a function of the serial passenger code number;

FIG. 5: shows a diagram of the average receipts as a function of the serial passenger code number;

FIG. 6: shows a detail from a first functional database;

FIG. 7: shows a diagram of the average receipts of various flight events for two predefined passenger code numbers;

FIG. 8: shows a detail from the second functional database; and

FIG. 9: shows a diagram illustrating the determination of information for specific flight events.

### DETAILED DESCRIPTION

In an embodiment, the present invention provides a method and a device which eliminates or at least reduces the disadvantages from the prior art.

Accordingly, the invention provides, in an embodiment, a method for analyzing airline passenger ticket mass data stocks, comprising the steps:
a. linking ticket data with flight schedule information in order to form a database comprising ticket coupon data for each flight event;
b. ensuring that the individual ticket coupons for each flight event are sorted in accordance with the respective ticket coupon receipts in a predefined order;
c. determining the receipts for each flight event as a function of the number of the serial passenger code number in accordance with the sorted ticket coupons;
d. determining calibration parameters of a function Yᵢ(X) for each individual flight event i, where Yᵢ stands for the receipts and X stands for the serial passenger code number, wherein the calibration of the function Yᵢ(X) is carried out on the basis of the determined receipts as a function of the serial passenger code number, in such a way that the deviations of the functional values Yᵢ from the determined receipts are as small as possible; and
e. combining a plurality of calibrated functions into clusters which can be assigned on the basis of flight information.

The invention also relates to a computer program product for analyzing airline passenger ticket mass data stocks according to the method according to an embodiment of the invention.

The method according to an embodiment of the invention makes it possible to make even very extensive airline passenger ticket mass data stocks useable in such a way that many limitations relating to the acquirable information, which are known from the prior art, can be overcome on the basis of computer capacity which is usually not available. For this purpose, a function is calibrated for each of the individual flight events from an airline passenger ticket mass data stock and a plurality of similarly calibrated functions are combined into clusters which can be assigned on the basis of flight information. With the functions which are obtained in this way, different detailed analyses and predictions can be carried out for a flight route or for all the flight routes of a cluster even, as shown below, using computers which are not very powerful, without having to have recourse to subjective suppositions or strategically estimated correction factors, as was usually necessary in the prior art owing to a lack of computer power.

It is to be noted here that the computer capacity which is required for calibrating the specified functions is not necessarily less than that which is required for determining key figures according to the prior art. However, the functions which are determined with the method according to an embodiment of the invention and can be combined into assignable clusters permit extensive and detailed analyses subsequent to the method according to an embodiment of the invention, without repeated recalculation of characteristic values or other numerical methods which have to be applied to the entire airline passenger ticket mass data stocks being necessary for individual analysis steps. The extensive and detailed analyses with the method according to an embodiment of the invention therefore require computing power which is less by a multiple than in the prior art, in so far as corresponding analyses were at all possible in said art, and can accordingly also be carried out on less powerful computers.

In the method according to an embodiment of the invention, in a first step ticket data is linked to flight schedule information in order therefore to obtain a database with ticket coupon data for any flight event.

The ticket data essentially comprises data such as is known from the airline passenger ticket mass data stocks according to the prior art. Data such as, for example, travel route (itinerary) information and ticket information is available for any individual airline ticket which is purchased from an airline in a predefined time period. The travel route (itinerary) information can contain information about the flight route comprising the point of departure and point of arrival as well as, if appropriate, intermediate stops, the date of the flight and/or the departure time and arrival time of the individual partial routes as well as the corresponding flight numbers. The ticket information preferably comprises the respective ticket receipts and the booked passenger class, for example “first”, “business” or “economy”.

Those airline tickets which relate to a flight connection with at least an intermediate stop and a plurality of partial flight routes may already be stored in the ticket data in such a way that a separate set of data with corresponding information about the partial flight route in the form of partial route ticket data is stored for each of the partial flight routes. If this is not the case, the ticket data of an airline ticket for a flight connection with a plurality of partial routes is preferably divided into partial route ticket data, that is to say into a plurality of data sets, each relating to one of the partial routes, before or during the combination of the ticket data with flight schedule information. Values which are available exclusively for the total flight route such as, for example, the ticket receipts, may, for example, be divided among the individual partial route ticket data items in accordance with the lengths of the individual partial flight routes.

The flight schedule information comprises information on all flights to which the ticket data relates, i.e. flight information relating to all the flights which are carried out by the airline in the same time period and for which ticket data is also available. The individual flight information items preferably contain not only information about the flight route but also the departure time and arrival time (if appropriate including the date) and also information about the type of aircraft used, the total number of seats, the seating configuration as portions of the different passenger classes of the total number of seats and/or the seating configuration as the respective total number of seats in different passenger classes. The flight information can also comprise the flight numbers. The information about the flight route can contain geographic information about the departure airport and arrival airport, for example information about the continent, the region and/or the city in which the airports are respectively located, as well as geographic positional data. The information about the flight route can further comprise information about the length of the route and/or the great circle distance between the departure airport and arrival airport.

For linking of the ticket data with the flight schedule information, the flight information of that flight which relates to a data set of the ticket data is added to each individual data set of the ticket data. The flight route, the departure time and the arrival time and/or the flight number can be used for linking here.

The step of linking the ticket data with flight schedule information results in a ticket coupon database in which each individual ticket or partial route ticket comprises, compared to the original ticket data or partial route ticket data, additional information relating to the implementation of the flight to which the respective ticket or partial route ticket relates. This additional information can include, in particular, the type of aircraft, the total number of seats and/or the seating configuration of the aircraft with which the respective flight was carried out.

In the next step it is ensured that the individual ticket coupons for each flight event are sorted in the ticket coupon database in accordance with the respective ticket receipts in a predefined order. In particular, the ticket coupons can be sorted in a descending or ascending order. In the case of sorting in a descending order, the first ticket coupon is then that with the highest ticket receipts, and the last ticket coupon that with the lowest ticket receipts for the respective flight event. In the case of sorting in an ascending order, the first ticket coupon is that with the lowest ticket receipts, and the last ticket coupon that with the highest ticket receipts for the respective flight event.

“Ensuring” in this context means that at the end of this method step the ticket coupons for each flight event are actually sorted in the predefined order. For this purpose, it is possible to detect, for example within the scope of suitable checking, whether the ticket coupons for a flight event already have the desired order. Only if this is not to be the case can the ticket coupons then be correspondingly re-sorted. As an alternative to checking with subsequent possible sorting it is also possible to apply a sorting algorithm to the ticket coupons without previous checking, wherein the sorting algorithm is preferably discontinued when it is detected that the ticket coupons are completely sorted. Methods for checking the order of the ticket coupons and for sorting the ticket coupons into a predefined order are known from the prior art. If it can be assumed for other reasons that the ticket coupons are already appropriately sorted (for example owing to correspondingly pre-sorted initial data), no action is necessary for the method step of ensuring the desired order.

The receipts for each flight event are subsequently determined as a function of the serial passenger code number in accordance with the sorted ticket coupons. The receipts to be determined may be, in particular, the average receipts or the cumulated receipts.

The “average receipts” can be calculated “as a function of the serial passenger code number” on the basis of the sum of the ticket receipts of the sorted ticket coupons, starting from the first ticket coupon up to a serial passenger code number, divided by the serial passenger code number. The determination of the “cumulated receipts as a function of the serial passenger code number” occurs in a basically analogous fashion to this, but the division by the serial passenger code number is dispensed with here.

For the purpose of illustration, the creation of a value table for each flight event on the basis of the sorted ticket coupons can be seen in this step. Passenger code numbers, which run from one up to the number of passengers actually transported in the flight event in question, serve as arguments of the value table. The average or cumulated receipts are represented as functional values, starting from the first ticket coupon (for example in the case of sorting of the ticket coupons with the highest ticket receipts in a descending order), as a function of the serial passenger code number, and the corresponding receipts can be formed by the sum of the ticket receipts of the sorted ticket coupons starting from the first ticket coupon up to the serial passenger code number, divided by the serial passenger code number in the case of average receipts.

The average receipts can be determined as a function of the serial passenger code number for each flight event in particular, by the following steps which are economical in terms of resources in respect of the computer capacity required for them:
a. determining the cumulated receipts as a function of the serial passenger code number; and
b. dividing the cumulated receipts by the associated serial passenger code number.

In order to determine the cumulated receipts, the ticket receipts of the ticket coupons which are preferably sorted in a descending order are preferably summed sequentially starting from the first ticket coupon, wherein the respective number of summed ticket coupons corresponds to the cumulated receipts of the serial passenger code number. The individual cumulated receipts are subsequently divided by the respectively associated serial passenger code number in order to obtain the average receipts.

If the receipts are determined as a function of the serial passenger code number for each flight event, a function Yᵢ(X) can be subsequently calibrated for each flight event. In this function, the index i stands for the respective flight event, and Yᵢ stands for the receipts as a function of X, of the serial passenger code number.

A function which can be correspondingly calibrated is a predefined function with at least one predefinable coefficient. The coefficients can be selected in such a way that the deviations of the function values Yᵢ from the determined receipts for each passenger code number X are as small as possible. The determination of the corresponding coefficients of the function Yᵢ(X) is denoted in relation to this invention as a calibration of the function Yᵢ(X) and can be carried out, for example, according to the method of the least mean squares. The predefinable coefficients are also referred to as “calibration parameters”. In other words, the calibration of the function Yᵢ(X) is therefore carried out on the basis of the determined receipts as a function of the serial passenger code number in such a way that the deviations of the function values Yᵢ from the determined receipts are as small as possible.

It is preferred if the range of the function Yᵢ(X) for passenger code numbers X, for which receipts have actually been determined is monotonously rising or monotonously falling. The number of calibration parameters of the function Yᵢ(X) is preferably less than or equal to 10, more preferably less than or equal to 5, more preferably less than or equal to 3. By means of a corresponding function Yᵢ(X), the expenditure of resources for the calibration and, if appropriate, for the subsequently explained combination into clusters can be reduced.

It is particularly preferred if the function Yᵢ(X) comprises the function

Yᵢ(X)=Aᵢ×X^{m}^{ᵢ} (equation 1)

with the calibration parameters Aᵢ and mᵢ. Since this function has only two calibration parameters, the calibration can be carried out in a particularly economical way in terms of resources. At the same time it has become apparent that this function usually maps the cumulated or average receipts of a flight event well.

In order to carry out the necessary calibration of the preferred function Yᵢ (X)=Aᵢ×X^{m}^{ᵢ} as economically as possible in terms of resources, it is preferred to logarithmize the abovementioned function so that the linear equation

Yᵢ*=mᵢ×log X+log Aᵢ (equation 2)

or

Yᵢ*=mᵢ×log X+Bᵢ where B=log Aᵢ (equation 3)

is obtained. For the calibration parameter Aᵢ the following then applies

Aᵢ=10^{B}^{ᵢ} (equation 4)

The specified linear equation can easily be calibrated in a way which is economical in terms of resources for each flight event using the receipts determined in the proceeding step, as a function of the serial passenger code number, wherein the optimization can have the objective of, in particular, maximizing the degree of certainty R² of the linear equation. Experience has shown that in 98% of examined flight events a degree of certainty R² of over 99% can be achieved.

Irrespective of the ultimate function Yᵢ(X) it is particularly preferred during the calibration if the calibration is carried out only on the basis of a predetermined range of the resulting profile of the receipts, in particular of a coherent portion starting from the first or the last serial passenger code number. The calibration can therefore be carried out on the basis of a relatively small number of values, as a result of which the computer power which is necessary for the calibration can be reduced. The portion of the serial passenger code numbers to be used for the calibration is preferably 60-80%, more preferably 70%.

Once the calibration for each individual flight event from the ticket coupon database is concluded, the values (for example Bᵢ and mᵢ) determined in the calibration and, if appropriate, the respective degree of certainty R² can be buffered together with the associated flight information. For example, the corresponding information can be stored in a first functional database which is significantly smaller in size compared to the ticket data or the ticket coupon database. The first functional database then comprises precisely one data set for each flight event compared to one data set per ticket in the ticket data or the ticket coupon database.

In order to still significantly increase the possibilities of subsequent analysis and also of the combination into clusters as described below, it is preferred if not only the specified determined values but also values relating to the loads of the individual passenger classes be determined for the flight event. These values can be buffered, for example, in the first functional database. The load values can be specified here as an absolute number of passengers in the individual passenger classes or as a portion of occupied seats in the individual passenger classes. The number of the data sets to be buffered, for example, in the first functional database does not change as a result of this but instead continues to correspond to the number of different flight events.

The individual flight events are subsequently combined, using the respective calibration values (for example Bᵢ and mᵢ) into clusters which can be assigned on the basis of flight information. “Clusters which can be assigned on the basis of flight information” means in this context that the individual clusters are defined in such a way that a flight event can be assigned uniquely to a specific cluster solely on the basis of flight information thereof. The clusters can be formed on the basis of flight information, for example, according to times of the year or calendar months, departure points and destination points or respective regions, type of flight (for example long haul, short haul, feeder flight), length of route, also great circle distances etc.

For the combination of individual flight events into clusters it can be checked whether a group of flight events which can be clearly defined in respect of flight information has sufficiently similar calibration values (for example Bᵢ and mᵢ) i.e. the calibration values of the individual flight events deviate from one another only within a predefined scope. If this is the case, common calibration values (for example B̅ and m̅) can be determined for all the flight events of this cluster. The flight events can then be combined into one cluster, with the result that only an individual function or common calibration values (for example B̅ and m̅) have to be stored for all the flight events of this cluster. The common calibration values (for example B̅ and m̅) can be found, for example, by forming mean values. If a flight event cannot be assigned to any definable group, the previously determined individual calibration values (for example Bᵢ and mᵢ) can be retained for the corresponding flight event.

The common calibration values (for example B̅ and m̅) for the individual clusters are stored, together with the information which permits unique assignment of flight events to this cluster, and the individual calibration values (for example Bᵢ and mᵢ) of flight events which cannot be assigned to a cluster, are stored together with associated flight information in, for example, a second functional database.

Trials with the method according to an embodiment of the invention have shown that individual calibration values (for example Bᵢ and mᵢ) of flight events can be combined into clusters, for example on the basis of regions and combinations of regions (for example flight events within Europe to a hub, which flight events can also be referred to as feeder flights, flight events between Europe and entire regions on other continents such as, for example, North America) as well as a function of the calendar month. In particular, flight events in specific regions or between regions and in a specific calendar month, but over several years, can also be combined into one cluster, wherein this is basically possible even in the case of market conditions which have changed over the years owing to changes in competition, for example. Likewise, flight events can often be combined into clusters independently of the seating capacity of the aircraft models which are used.

The number of functions which are thus determined by means of the calibration values (for example Bᵢ and mᵢ) and combined into clusters is smaller compared to the number of data sets in the original ticket data, by at least an order of magnitude, as a rule even several orders of magnitude. However, the determined functions are simultaneously, in contrast to the prior art, not only static characteristic values but also permit extensive analyses which in the prior art could be carried out on the basis of airline passenger ticket mass data stocks only with a high computer capacity, if they could be carried out at all. The analyses on the basis of the calibration values determined according to an embodiment of the invention can, on the other hand, also be carried out with computers which are significantly less powerful in comparison.

Of course, simplifications and deviations with respect to the original ticket data arise owing to the calibration according to an embodiment of the invention and the combination into clusters, checks have shown, however, that the corresponding inaccuracies are negligible and, in particular, are more than made up for by the analysis possibilities which have firstly become possible by virtue of the method according to an embodiment of the invention.

Even if the described combination into individual clusters already makes it possible to combine a multiplicity of flight events, this is frequently not possible or possible only by accepting serious inaccuracies in the case of flight events with significantly different distribution of passengers in the various booking classes, for example “first”, “business” and “economy”. In this context, it is irrelevant whether the different distribution of the passengers into the various booking classes occurs owing to different seating configurations of the respectively used aircraft or owing to fluctuations in the bookings.

In one preferred embodiment, the invention has recognized that there is a relationship between the portion of passengers in the relatively high booking classes (for example “first” and “business”)—referred to as “normal fare passengers”—in a freely predefined fixed number of passengers and the receipts as a function of the serial passenger code number, and this relationship is linear. It is therefore preferred to take into account this linear relationship in the combination of the individual flight events into clusters which can be assigned on the basis of flight information. As a result, the number of clusters which are required for mapping all the flight events can be reduced further and the requirements in terms of computer capacity for the further processing can be reduced further.

In order to be able to perform the corresponding combination, it is necessary for information about the loads of the individual passenger classes to be available for each flight event. However, the corresponding information can readily be determined and stored, for example, in the first functional database (see above).

The combination of flight events with different loads of the individual passenger classes into clusters which can be assigned on the basis of flight information, comprises the following steps:
a. determining the gradients jₐ, j_{b}, . . . on the basis of linear equations for predefined passenger code numbers a, b, . . . , which represent a relationship between the number of standard fare passengers n or the portion of standard fare passengers in a freely predefined fixed number of passengers and the receipts of the flight events to be combined for the predefined passenger code numbers a, b, . . . , wherein the receipts for the predefined passenger code numbers a, b, . . . are determined as a function of the number of standard fare passengers n or the portion of standard fare passengers in the freely predefined fixed number of passengers is determined by solving the functions Yᵢ(X) for the respective flight events, and wherein the number of predefined passenger code numbers a, b, . . . and the number of linear equations corresponds in each case to the number of calibration parameters of the functions Yᵢ(X); and
b. determining common calibration values for a predefined number of standard fare passengers n̅ or a portion of standard fare passengers in the freely predefined fixed number of passengers.

For the combination of flight events with a different loads of the individual passenger classes into clusters which can be assigned on the basis of flight information, the functions Yᵢ(X) for the flight events concerned are therefore firstly each solved for predefined passenger code numbers a, b, . . . and the results (that is to say the receipts) which are achieved in the process are determined as a function of the number of standard fare passengers n or the portion of standard fare passengers in a freely predefined fixed number of passengers of the respective flight event. For the predefined passenger code numbers a, b, . . . , linear equations can then be respectively determined which represent a relationship between the number of standard fare passengers n and the portion of standard fare passengers in the freely predefined fixed number of passengers and the receipts for the predefined passenger code numbers a, b, . . . . The gradient of the straight lines jₐ, j_{b}, . . . can be determined on the basis of the linear equations. The gradients jₐ, j_{b}, . . . can be stored, for example, as parameters for the corresponding cluster, for example, in the second functional database. If the gradients of the straight lines jₐ, j_{b}, . . . are determined on the basis of the portion of the standard fare passengers in the freely predefined fixed number of passengers, the gradients jₐ, j_{b}, . . . can also be identical.

The common calibration values (for example B̅ and m̅) can be identical to the calibration parameters (for example Bᵢ and mᵢ) of a specific flight event of the cluster. The associated number of standard fare passengers n̅ corresponds then to the number of standard fare passengers nᵢ of the corresponding flight event. However, if appropriate it is also possible to form mean values or the like.

If not only the common calibration values (for example B̅ and m̅) but also the described gradients jₐ, j_{b}, . . . and the associated number of standard fare passengers n or the portion thereof in the freely predefined fixed number of passengers are available for a cluster, the calibration parameters (for example Bᵢ and mᵢ) for individual flight events can be adapted using the gradients jₐ, j_{b}, . . . for the known passenger code numbers a, b, . . . as a function of the deviation from the predefined number of standard fare passengers n or the portion thereof in the freely predefined fixed number of passengers, in such a way that the resulting function represents the respective flight event sufficiently precisely.

This can be clarified using the example of the preferred function Yᵢ(X)=Aᵢ×X^{m}^{ᵢ}. In this context, the function Y(X)=A×X^{m} is solved for the passenger code numbers a, b with the common calibration values B̅ and m̅), with the result that the following is obtained:

Y̅(a)=10 ^{B̅}×a ^{m̅} (equation 5)

and

Y̅(b)=10 ^{B̅}×b ^{m̅}. (equation 6)

For any desired flight with a known number of standard fare passengers nᵢ from the corresponding cluster it is possible to determine readily the individual function Yᵢ of this flight event or the calibration parameters Bᵢ and mᵢ thereof on the basis of

Yᵢ(a)=10^{B}^{ᵢ}×a^{m}^{ᵢ}= Y̅(a)+jₐ×(nᵢ− n̅) (equation 7)

and

Yᵢ(b)=10^{B}^{ᵢ}×b^{m}^{ᵢ}= Y̅(b)+j_{b}×(nᵢ− n̅) (equation 8)

This permits even flight events which, owing to common features in the flight information, can basically be combined into clusters which can be assigned on the basis of flight information, to be able also actually to be combined into one cluster owing to a different number of standard fare passengers or proportion of standard fare passengers in the freely predefined fixed number of passengers even in spite of significantly different calibration parameters.

It is preferred if the average value of the number of standard fare passengers or the portion thereof in the freely predefined fixed number of passengers is determined for all the flight events of a cluster. The standard deviation of the number of standard fare passengers or the portion of the standard fare passengers in the freely predefined fixed number of passengers from the respective straight line can preferably also be determined.

Since a correspondingly expanded combination of flight events is possible, the number of required clusters to map all the flight events according to the initial ticket data drops. Correspondingly, the number of the data sets which are to be stored, for example, in a second functional database and which contain the information about the individual clusters drops. Checks have shown that, compared to approximately 12.6 million ticket data items (sets) from the first method step, the number of data sets can be reduced to approximately 2 thousand. In contrast to the prior art in this context, the resulting data sets are, however, not limited to static key figures but instead offer the possibility of carrying out detailed analyses of a plurality of flight events which can be combined on the basis of flight information, and also of individual flight events with sufficient accuracy. Owing to the comparatively small number of data sets, corresponding analyses can also be carried out in this context with the aid of computers which are not very powerful. In so far as corresponding analyses were at all possible in the prior art, they would have required extremely powerful computers and an enormous expenditure of time in order to deal alone with the significantly higher number of original ticket data items present in the prior art.

An additional bonus effect arises as a result of the described extended combination of flight events into clusters which can be assigned on the basis of flight information in that, for example, even changes to the aircraft size of aircraft models used on a route or various seating configurations can be projected and estimated in advance. Information acquired in this way can be taken into account in the fleet planning or in the production of the flight schedule by an airline, and also in a new design of an aircraft by an aircraft manufacturer.

The method according to an embodiment of the invention also permits the best possible loads, in particular of the relatively high booking classes (for example “first” and “business”) by the standard tariff passengers to be ensured in the fleet planning and in the design of new aircraft. This makes it possible to significantly reduce the risk of seats in the relatively high booking classes being continuously unused and having to be carried constantly as empty weight in an aircraft, which would ultimately also unnecessarily increase the fuel consumption.

The optimum number of seats for standard fare passengers in a cluster which can be assigned on the basis of flight information, i.e. that number which ensures an optimum load, is determined preferably by adding the average number of standard fare passengers or the portion of standard fare passengers in the freely predefined fixed number of passengers of a cluster and of twice the standard deviation of the number of standard fare passengers or of the portion of standard fare passengers in the freely predefined fixed number of passengers of the same cluster. With an optimum number of seats determined in this way for standard fare passengers, the loads of the corresponding seats in a cluster can be optimized, with the result that the empty weight to be carried in the flight events which can be assigned to the cluster is in total minimal and correspondingly a saving in fuel can be achieved. The method for optimizing the loads of the seats and therefore ultimately for continuously reducing the fuel consumption deserves separate protection, under certain circumstances.

The computer program product according to an embodiment of the invention serves to execute the method according to an embodiment of the invention. Reference is therefore made to the statements above. The computer program product can be present in the form of a diskette, a DVD (Digital Versatile Disc), a CD (Compact Disc), a memory stick or any other desired storage medium.

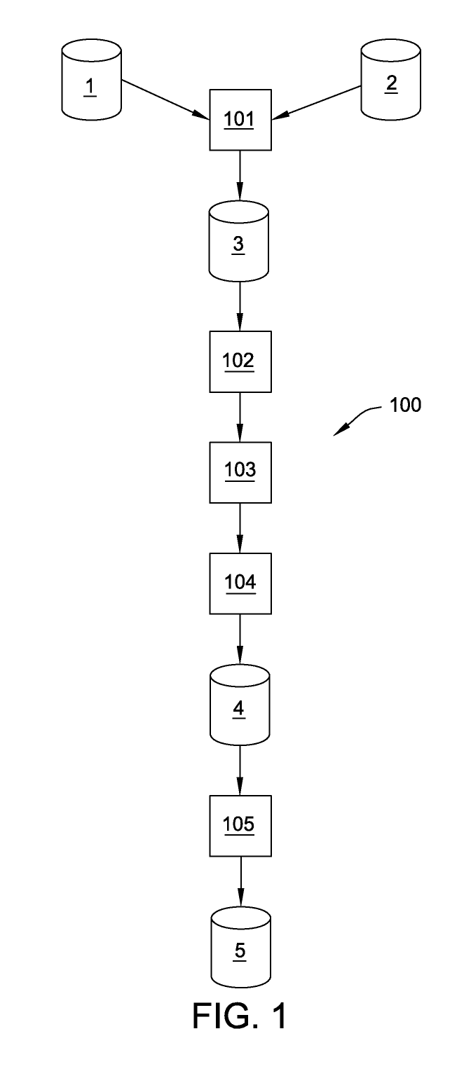

FIG. 1 is a schematic illustration of the method 100 according to an embodiment of the invention. In a first step 101, the ticket data which is stored in a first data memory 1 and flight schedule information which is stored in a second data memory 2 are combined to form a ticket coupon database 13 and stored in a third data memory 3.

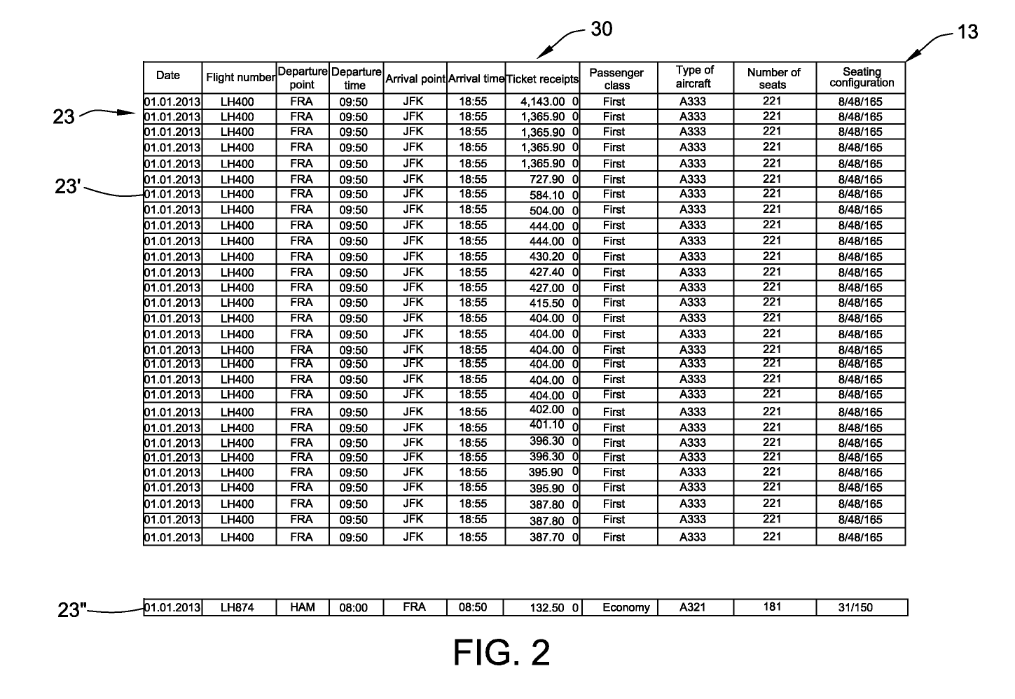

FIG. 2 illustrates a detail from a ticket coupon database 13. For each individual ticket coupon 23 there is a separate data set which contains information about
date of the flight event,
the flight number,
the departure point,
the departure time,
the arrival point,
the arrival time,
the ticket receipts 30 for the ticket coupon,
the passenger class,
the type of aircraft with which the flight was actually carried out,
the number of seats in the aircraft with which the flight was actually carried out, and
the seating configuration of the aircraft with which the flight was actually carried out.

The information “date of the flight event”, “flight number”, “departure point”, “departure time”, “arrival point” and “arrival time” are contained both in the ticket data and in the flight schedule information and are used to uniquely link the flight schedule information to the ticket data. The information “ticket receipts” and “passenger class” in the ticket coupon database 13 originates from the ticket data which contains information about “type of aircraft”, “number of seats” and “seating configuration” from the flight schedule information.

The ticket coupon database 13 exclusively contains individual flight routes. If a ticket from the ticket data comprises a plurality of partial routes, the corresponding ticket is split into a plurality of ticket coupon 23, with the result that a separate ticket coupon 23 is available for each partial route. In the illustrated example, the ticket coupons 23′ and 23″ form the two partial routes of a ticket from the ticket database for the total flight route (itinerary) Hamburg (HAM)—New York, John F. Kennedy Airport (JFK) with a transfer in Frankfurt (FRA).

In the following step 102 it is ensured that the ticket coupons 23 of each individual flight event in the ticket coupon database 13 are sorted according to a predefined criterion, specifically in a descending order according to the ticket receipts 30 of each ticket coupon 23 for the corresponding flight event. In the illustrated example, the ticket coupons 23 of an individual flight event are fed for this purpose to a sorting algorithm, for example a bubble sorting algorithm which correspondingly sorts the ticket coupons 23. The sorting algorithm is discontinued as soon as the ticket coupons 23 are present in the correct order. If the ticket data 23 for a flight event is already sorted when it is fed to the sorting algorithm, the latter is already discontinued after the single pass.

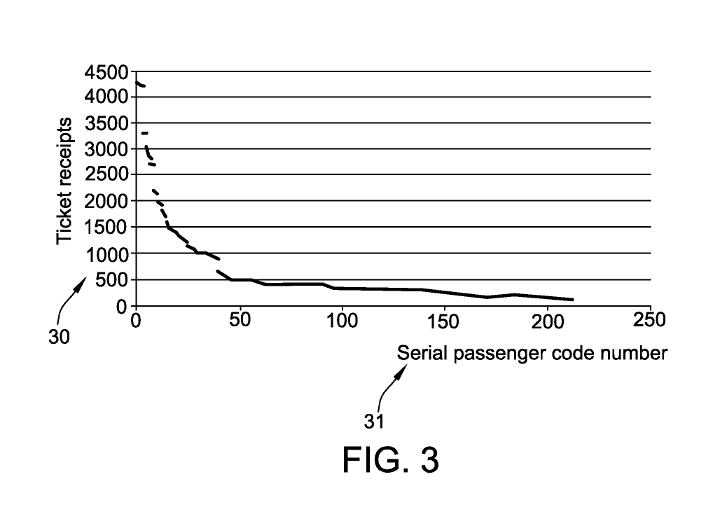

FIG. 3 illustrates, in an example, the ticket receipts 30 of the sorted ticket coupons 23 plotted against the serial passenger code number 31 for an individual flight event, wherein the passenger code number 31 runs consecutively from one up to the number of ticket coupons 23 for the respective flight event.

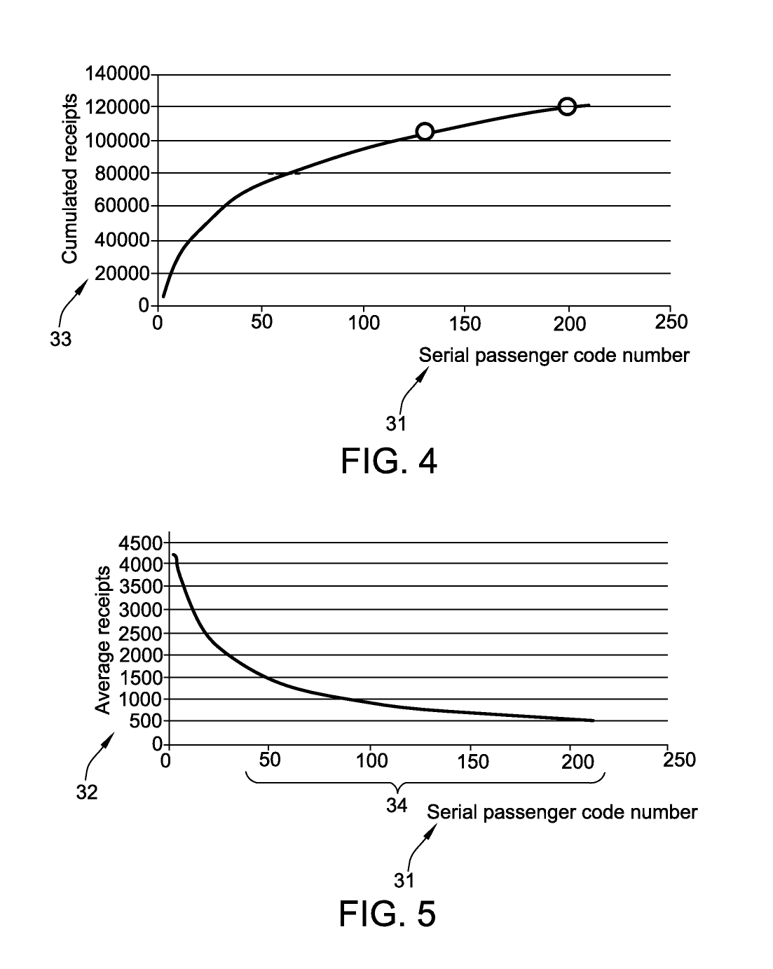

In step 103, the average receipts 32 for each flight event are determined as a function of the serial passenger code number 31. For this purpose, in an intermediate step, the cumulated receipts 33 are firstly calculated as a function of the serial passenger code number 31 in that the ticket receipts 30 of the sorted ticket coupons 23 are summed in order starting from the first ticket coupon, and determined in accordance with the number of summed ticket coupons 23, which corresponds to the serial passenger code number 31. The result of this intermediate step for the flight event from FIG. 3 is illustrated in FIG. 4.

Subsequently, the individual cumulated receipts 33 are divided by the respectively associated serial passenger code number 31, in order in this way to obtain the average receipts 32 as a function of the serial passenger code number 31. The average receipts 32 for the flight event from FIGS. 3 and 4 are illustrated in an example in FIG. 5.

On the basis of the average receipts 32 illustrated in an example in FIG. 5, in step 104 the function

Yᵢ(X)=Aᵢ×X^{m}^{ᵢ} (equation 1)

is calibrated for each flight event as a function of the serial passenger code number 31. In this function, the index i stands for the respective individual flight event, Yᵢ stands for the average receipts and X stands for the serial passenger code number. For the calibration, the calibration parameters Aᵢ and mᵢ of the function are optimized in such a way that the deviations from the average receipts 32 determined in the preceding step 103, as a function of the serial passenger code number 31 for each flight event are as small as possible. The calibration is performed here only on the basis of 70% of the serial passenger code numbers 31 and specifically that 70% is performed with the highest passenger code numbers 31. The corresponding portion is indicated as the region 34 in FIG. 5.

In order to carry out the necessary calibration in a way which is as economical as possible in terms of resources it is preferred to use the above mentioned function in a logarithmized fashion, specifically as a linear equation

Yᵢ*=mᵢ×log X+log Aᵢ (equation 2)

or

Yᵢ*=mᵢ×log X+Bᵢmit Bᵢ=log Aᵢ. (equation 3)

The last-mentioned linear equation can be calibrated easily and in a way which is economical in terms of resources for each flight event using the average receipts 32 determined in the preceding step, as a function of the serial passenger code number 31, wherein the optimization can have the objective, in particular, of maximizing the degree of certainty R² of the linear equation. The parameter Aᵢ is obtained from

Aᵢ=10^{B}^{ᵢ}. (equation 4)

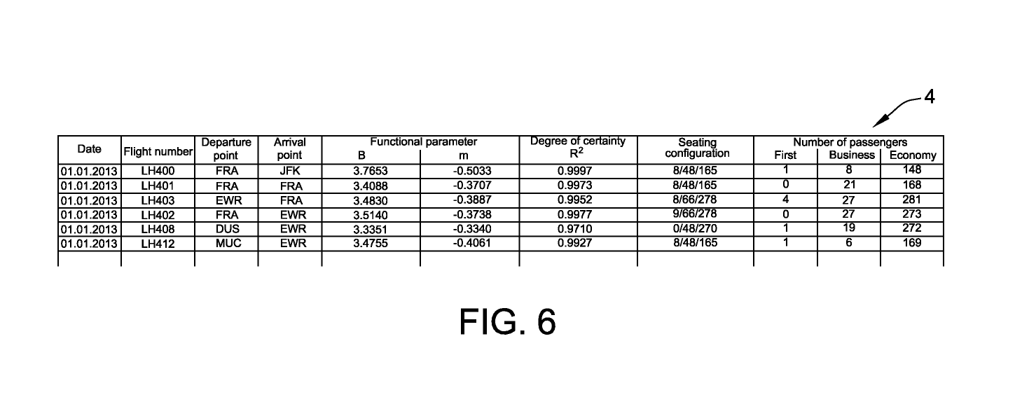

The functions which are calibrated corresponding for each flight event for which ticket data is present in the database 1 are stored in a first functional database 4 in the form of their calibration parameters Bᵢ and mᵢ. In addition to the calibration parameters Bᵢ and mᵢ, flight information relating to the respective flight event is also stored in the first functional database 4. The number of passengers divided according to classes is also stored in the first functional database 4. A detail from a corresponding first functional database 4 is illustrated in an example in FIG. 6.

In that only one data set for each flight event is stored for each flight event in the first functional database 4, the number of data sets in this database is already significantly reduced compared to the databases 1 and 3 with ticket data and ticket coupon data 13 for each individual ticket of each individual flight event.

In a further step 105, the individual data sets from the first functional database 4 are combined into individual clusters which can be assigned on the basis of flight information. Therefore, for example, the flights specified in FIG. 6 between Frankfurt (FRA) and North America or the two New York airports of John F. Kennedy (JFK) and Newark (EWR) can be combined to form a cluster which is then valid for all flights between Frankfurt and North America or New York. The cluster can also be limited here to flights in the January of a year.

In addition to the flights between Frankfurt and New York which are specified in FIG. 6, of course the first functional database 4 also contains a multiplicity of further flights which are associated with the specified cluster “Frankfurt-New York in January” (or “Frankfurt-North America in January”). The size of the aircraft or the seating configuration are, however, not a criterion for the formation of a cluster in the illustrated example.

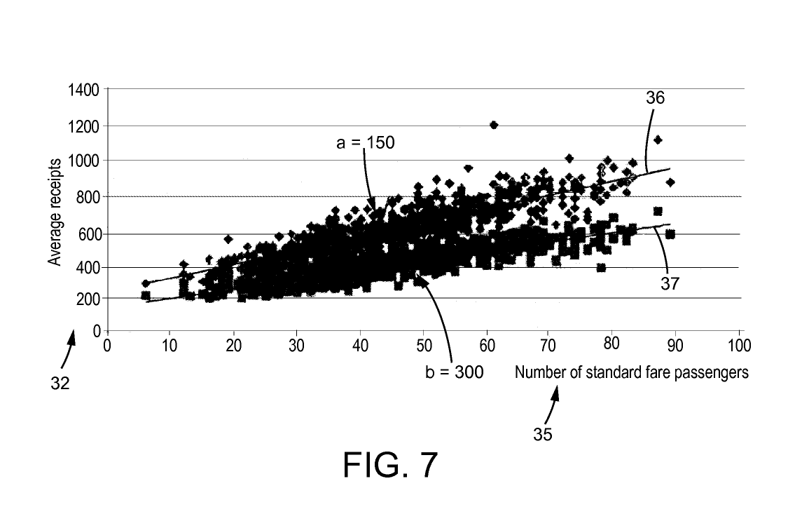

For the combination of the corresponding flight events of a cluster, the average receipts are firstly calculated for two predefined passenger code numbers a, b using the respective calibration parameters Bᵢ and mᵢ and the abovementioned function. In FIG. 7, the average receipts which are calculated in this way for the passenger code numbers a=150 and b=300 are illustrated, wherein the average receipts are illustrated plotted against the number of standard fare passengers, i.e. the passengers in the booking classes “first” and “business”, for the respectively corresponding flight event. The number of standard fare passengers can be extracted from the first functional database 4 (cf. FIG. 6, “number of passengers”).

For each of the predefined passenger code numbers a, b, in each case a straight line 36, 37 with a respective gradient jₐ, j_{b} can be approximated. Furthermore, in this step, common calibration parameters B̅ and m̅ as well as an associated number of standard fare passengers n are determined. These values may be, for example, the calibration parameters and the number of standard fare passengers of a specific flight event of the cluster.

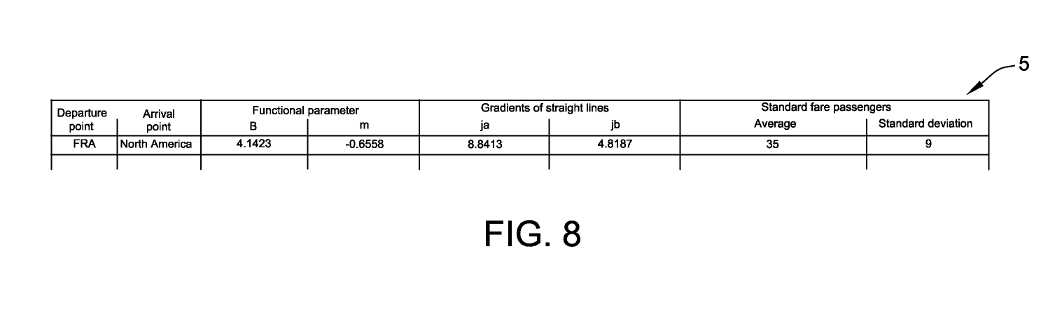

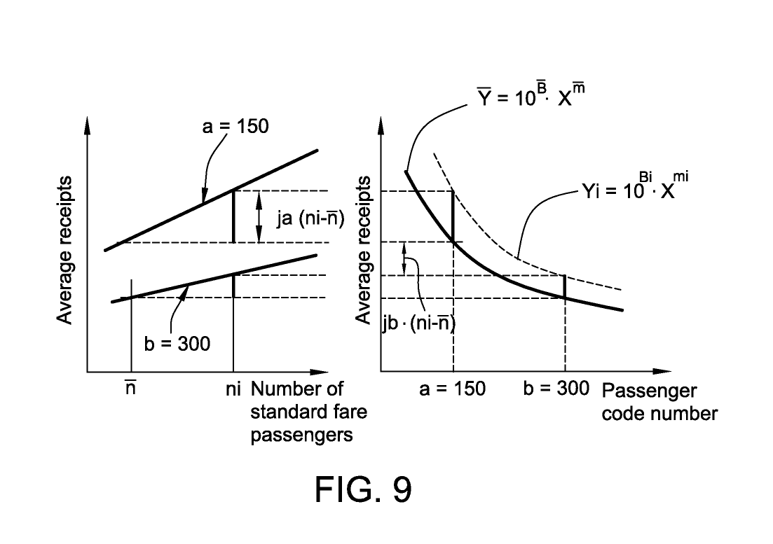

Furthermore, an average value and the standard deviation of the number of carried standard fare passengers can be determined for the flight events of the respective cluster. The corresponding information can be stored in a second functional database 5, as illustrated in an example in FIG. 8.

On the basis of the information relating to the common calibration values B̅ and m̅, the associated number of standard fare passengers n and the gradients jₐ, j_{b} for a cluster, the individual calibration parameters Bᵢ and mᵢ can be determined for individual flight events from this cluster, specifically as a function of the number of standard fare passengers of the individual flight event.

For this purpose, it is possible, for example, to solve the function Y(X)=A×X^{m} for the passenger code numbers a, b with the common calibration values B̅ and m̅), with the result that the following is obtained:

Y̅(a)=10 ^{B̅}×a ^{m̅} (equation 5)

and

Y̅(b)=10 ^{B̅}×b ^{m̅}. (equation 6)

For any desired flight with a known number of standard fare passengers nᵢ from the corresponding cluster it is then readily possible to determine the individual function Yᵢ of this flight event or the calibration parameters Bᵢ and mᵢ thereof on the basis of

Yᵢ(a)=10^{B}^{ᵢ}×a^{m}^{ᵢ}= Y̅(a)+jₐ×(nᵢ− n̅) (equation 7)

and

Yᵢ(b)=10^{B}^{ᵢ}×b^{m}^{ᵢ}= Y̅(b)+j_{b}×(nᵢ− n̅). (equation 8)

FIG. 9 is a further graphic illustration of this procedure for determining the individual calibration parameters Bᵢ and mᵢ of a specific flight event. On the basis of the gradients jₐ, j_{b} for two predefined passenger code numbers a=150 and b=300, it is possible to determine for each of these two passenger code numbers a, b a deviation from the known function ( Y̅) with common calibration values B̅ and m̅), a “shift” of the function (Yᵢ) and the calibration parameters Bᵢ and mᵢ which are changed in the process and which depend on the actual number of standard fare passengers nᵢ of the respective flight event.

As a result of the described combination it is possible to reduce even further the number of data sets in the second functional database 5 compared to the first functional database 4.

As a result, the method according to an embodiment of the invention provides a second functional database 5 which can map all the flight events contained in the initial ticket data with sufficient accuracy, but in contrast to this receives a number of data sets which is smaller by orders of magnitude. Owing to this significantly reduced size, the second functional database 5 can also be evaluated by less powerful computers. An additional bonus effect which was not possible in the prior art is that on the basis of the second functional database 5 determined in this way it is also possible to derive information and make predictions.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for analyzing airline passenger ticket mass data stocks, the method comprising:
a. linking ticket data with flight schedule information so as to form a database comprising ticket coupon data for each flight event;
b. ensuring that individual ticket coupons for each flight event are sorted in accordance with respective ticket coupon receipts in a predefined order;
c. determining receipts for each flight event as a function of a number of a serial passenger code number in accordance with the sorted ticket coupons;
d. determining calibration parameters of a function Yᵢ(X) for each individual flight event i, where Yᵢ stands for the receipts and X stands for the serial passenger code number, wherein calibration of the function Yᵢ(X) is carried out based on the determined receipts as a function of the serial passenger code number in such a way that deviations of functional values Yᵢ from the determined receipts are as small as possible; and
e. combining a plurality of calibrated functions into clusters which are assignable based on flight information.

2. The method as claimed in claim 1, wherein it is ensured that the individual ticket coupons for each flight event are sorted in accordance with the respective ticket coupon receipts in an ascending or descending order.

3. The method as claimed in claim 1, wherein the receipts to be determined are cumulated or average receipts.

4. The method as claimed in claim 1, wherein a range of the function Yᵢ(X) for the serial passenger code numbers X, for which the receipts have been determined is monotonously rising or monotonously falling.

5. The method as claimed in claim 1, wherein a number of the calibration parameters of the function Yᵢ(X) is less than or equal to 10.

6. The method as claimed in claim 1, wherein the function Yᵢ(X) is:
Yᵢ(X)=Aᵢ×X^{m}^{ᵢ}
with calibration parameters Aᵢ and mᵢ.

7. The method as claimed in claim 1, wherein, before or during the linking of the ticket data to the flight schedule information, the ticket data for a flight connection with a plurality of partial routes is divided into a plurality of partial route ticket data items, each relating to one of the partial routes.

8. The method as claimed in claim 1, wherein, in order to ensure the predefined order of the ticket coupons, a sorting algorithm is applied.

9. The method as claimed in claim 3, wherein the average receipts are determined as a function of the serial passenger code number by means of the following steps:
a. determining the cumulated receipts as a function of the serial passenger code number; and
b. dividing the cumulated receipts by the associated serial passenger code number.

10. The method as claimed in claim 6, wherein the function Yᵢ(X)=Aᵢ×X^{m}^{ᵢ} is logarithmized for the calibration.

11. The method as claimed in claim 1, wherein the calibration is carried out only on the basis of a predetermined range of a resulting profile of the receipts.

12. The method as claimed in claim 1, wherein values relating to loads of individual passenger classes are determined for each flight event.

13. The method as claimed in claim 1, further comprising combining individual flight events into clusters, wherein it is checked whether a group of flight events which can be clearly defined in respect of flight information has sufficiently similar calibration values, and, upon a determination of the sufficiently similar calibration values, common calibration values are determined for all the flight events of the cluster.

14. The method as claimed in claim 1, wherein the flight events with different loads of individual passenger classes are combined into clusters which are assignable based on the flight information by the following steps:
a. determining a gradient jₐ, j_{b}, . . . on the basis of linear equations for predefined passenger code numbers a, b, . . . , which represent a relationship between a number of standard fare passengers n or a portion of the standard fare passengers in a freely predefined fixed number of passengers and the receipts of the flight events to be combined for the predefined passenger code numbers a, b, . . . , wherein the receipts for the predefined passenger code numbers a, b, . . . are determined as a function of the number of standard fare passengers n or the portion of the standard fare passengers in the freely predefined fixed number of passengers is determined by solving the functions Yᵢ(X) for the respective flight events, and wherein a number of the predefined passenger code numbers a, b, . . . and a number of the linear equations corresponds in each case to a number of calibration parameters of the functions Yᵢ (X); and
b. determining common calibration values for a predefined number of standard fare passengers n̅ or a portion of the standard fare passengers in the freely predefined fixed number of passengers.

15. The method as claimed in claim 1, wherein an average value of a number of standard fare passengers or a portion thereof in a freely predefined fixed number of passengers is determined for all the flight events of a cluster.

16. The method as claimed in claim 15, wherein an optimum number of seats for standard fare passengers in the cluster is determined by adding the average number of standard fare passengers or the portion of the standard fare passengers in the freely predefined fixed number of passengers of the cluster and of twice the standard deviation of the number of standard fare passengers or of the portion of the standard fare passengers in the freely predefined fixed number of passengers of a same cluster.

17. A computer program product embodied on a non-transitory, tangible medium which when executed on a processor results in execution of the method as claimed in claim 1.

18. The method as claimed in claim 5, wherein the number of the calibration parameters of the function Yᵢ(X) is less than or equal to 3.

19. The method as claimed in claim 11, wherein the calibration is carried out only on the basis of a coherent portion of the serial passenger code number, wherein the portion of the serial passenger code numbers to be used for the calibration is 60-80%.

20. The method as claimed in claim 15, wherein a standard deviation of the number of standard fare passengers or a portion thereof in the freely predefined fixed number of passengers is determined for all the flight events of the cluster.
